(19) United States
(12) Patent Application Publication
(10) Pub. No.: US 2020/0065775 A1
(43) Pub. Date: Feb. 27, 2020

(54) System and Method for Determining and Reporting Cost Benefit of Maintenance and Repair for Facilities and/or Equipment

(71) Applicant: Predictive Service, LLC, Cleveland, OH (US)

(72) Inventors: Shawn Goertzen, Cleveland, OH (US); John Pucillo, Cleveland, OH (US)

(73) Assignee: Predictive Service, LLC, Cleveland, OH (US)

(21) Appl. No.: 16/106,132

(22) Filed: Aug. 21, 2018

(51) Int. Cl. G06Q 10/00; G06Q 10/06

(52) U.S. Cl. CPC G06Q 10/20; G06Q 10/0635; G06Q 10/06375

(57) ABSTRACT

A method is disclosed for determining the cost benefit of performing maintenance and/or making repairs to facilities and/or equipment. The method includes receiving a criticality indicator associated with a particular facility or item of equipment from a customer, calculating a cost savings the customer can expect to obtain by making an identified maintenance or repair for the particular facility or item of equipment, and providing the calculated cost savings to the customer. The criticality indicator is selected from a plurality of criticality indicators which indicate a relative criticality of the particular facility or item of equipment. The calculation of the cost savings is based at least in part on the criticality indicator associated with the particular facility or item of equipment. Once the customer has the cost savings information, they can make informed decisions about which maintenance and repairs they need to proceed with to improve cost savings.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The present invention generally relates to systems and methods for managing maintenance and repair for facilities and/or equipment and, more specifically, such systems and methods that determine cost benefit of maintenance and repair for facilities and/or equipment.

### BACKGROUND OF THE INVENTION

Owners of facilities and equipment must make many decisions about maintenance and repair of their facilities and equipment. These decisions can be complicated by limited budgets for maintenance and repair and the possibility of tremendous negative financial impact when not adequately performing maintenance and repairs. Owners of multiple facilities such as, for example, manufacturers, property and facility managers, hotels, school districts, universities, hospitals, service providers, contractors, utility authorities and municipalities, have an even more difficult decisions because of the volume of differing situations that must compete for limited repair and maintenance dollars.

Multi-location companies are typically inundated with many reports, most likely prepared by several different providers, with varied content and quality. With these varied reports, it is difficult to determine the true priorities of the problems, to determine which problems should be repaired and when, and to track the problems over time by equipment and/or location. Accordingly, there is a need in the art for improved systems and methods for managing maintenance and repair for facilities and equipment.

### SUMMARY OF THE INVENTION

Disclosed is a computer implemented method for determining cost benefit of making facility or equipment maintenance or repairs. The disclosed method comprises the steps of electronically receiving a criticality indicator associated with a particular facility or item of equipment from a customer, electronically calculating a cost savings the customer can expect to obtain by making an identified maintenance or repair for the particular facility or item of equipment, and electronically providing the calculated cost savings to the customer. The associated criticality indicator is selected from a plurality of criticality indicators electronically presented to the customer which indicates a relative criticality of the particular facility or item of equipment for the customer. The calculation is based at least in part on the criticality indicator associated with the particular facility or item of equipment.

Also disclosed is a system for determining cost benefit of making facility or equipment maintenance or repairs. The system comprises a processor and memory configured to carry out the steps of electronically receiving a criticality indicator associated with a particular facility or item of equipment from a customer, electronically calculating a cost savings the customer can expect to obtain by making an identified maintenance or repair for the particular facility or item of equipment, and electronically providing the calculated cost savings to the customer. The associated criticality indicator is selected from a plurality of criticality indicators electronically presented to the customer which indicates a relative criticality of the particular facility or item of equipment for the customer. The calculation is based at least in part on the criticality indicator associated with the particular facility or item of equipment.

Also disclosed is computer readable medium containing program instructions for electronically receiving a criticality indicator associated with a particular facility or item of equipment for a customer, electronically calculating a cost savings the customer can expect to obtain by making an identified maintenance or repair for the particular facility or item of equipment, and electronically providing the calculated cost savings to customer. The associated criticality indicator is selected from a plurality of criticality indicators electronically presented to the customer which indicates a relative criticality of the particular facility or item of equipment for the customer. The calculation is based at least in in part on the criticality indicator associated with the particular facility or item of equipment.

From the foregoing disclosure and the following more detailed description of various preferred embodiments it will be apparent to those skilled in the art that the present invention provides a significant advance in the technology and art of systems and methods for managing maintenance and repair of facilities and equipment. Particularly significant in this regard is the potential the invention affords for providing consistent, accurate, and reliable information upon which decisions can be based. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a block diagram of a system for managing maintenance and repair for facilities and equipment according to the present invention.

FIG. 1A is a block diagram of a service provider server of the system of FIG. 1.

FIG. 1B is a block diagram of a customer computer of the system of FIG. 1.

FIG. 2 is a software look-upon table for class, severity multiplier, and size multiplier of the system for managing maintenance and repair for facilities and equipment of FIG. 1.

FIG. 3 is a software look-upon table for loss of production percentage of the system for managing maintenance and repair for facilities and equipment of FIG. 1.

FIG. 4A is a software look-upon table for maintenance and repair of electric motors of the system for managing maintenance and repair for facilities and equipment of FIG. 1.

FIG. 4B is a continuation of the software look-upon table of FIG. 4A.

FIG. 5 is a screen shot of a data input window for equipment of the system for managing maintenance and repair for facilities and equipment of FIG. 1.

FIG. 6 is a screen shot of a reporting window of the system for managing maintenance and repair for facilities and equipment of FIG. 1 which displays various costs and savings relating to the repair of a particular piece of equipment.

FIG. 7 is a screen shot of a reporting window of the system for managing maintenance and repair for facilities and equipment of FIG. 1 which displays a list of repairs of particular pieces of equipment and the savings for each repair.

FIG. 8 is a screen shot of a reporting window of the system for managing maintenance and repair for facilities and equipment of FIG. 1 which displays global information for including cost benefit for all maintenance and repairs.

FIG. 9 is a graph showing problem percentage for a particular site of a customer, all sites of a particular customer, and all sites of all customers for the service provider.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods for managing maintenance and repair for facilities and/or equipment disclosed herein. The following detailed discussion of various alternative and preferred embodiments will illustrate the general principles of the invention with respect to inspection of electrical, building, mechanical, utility, and process equipment or systems. Other embodiments will be apparent to those skilled in the art given the benefit of this disclosure.

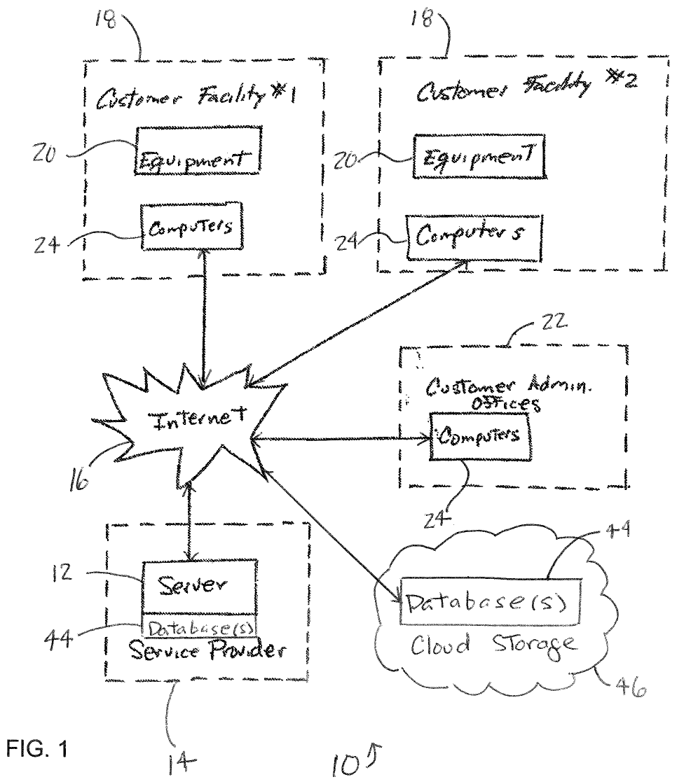

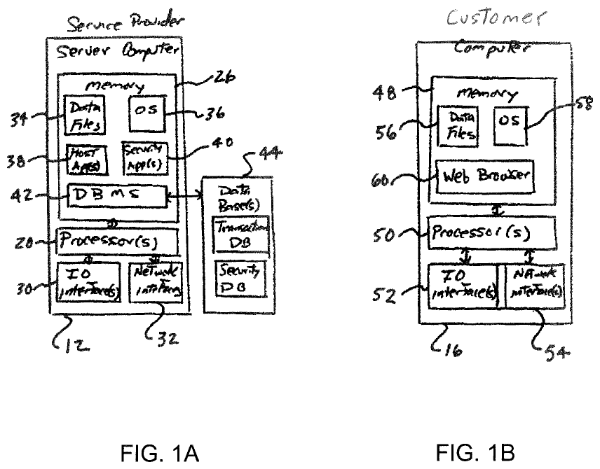

Referring now to the drawings, FIG. 1 shows a system 10 for managing maintenance and repair for facilities and/or equipment according to the present invention. The illustrated system 10 includes at least one server 12 programmed with computer software for carrying out a method for managing maintenance and repair for facilities and/or equipment according to the present invention. The illustrated server 12 is located at a service provider 14 and can be accessed by a customer via a communication system 16 as software as a service but alternatively can be located at any other suitable location such as, for example, cloud based, a customer computer or computer network, or the like. It is noted, for example, that the service provided could be eliminated and the software could reside on a server of a company having at least one facility. The illustrated system 10 also includes a plurality of customer facilities 18 each having equipment 20 that requires periodic maintenance and repair such as, for example, an electric motor or the like. Typically, each customer facility 18 has more than one item of equipment 20 that requires periodic maintenance and repair. The illustrated system 10 also includes a customer administrative office 22. While the illustrated embodiment shows only two customer facilities 18 and one administrative office, it should be appreciated that a customer can have any other quantity of facilities 18 and/or administrative offices 22 and typically would have more than two facilities 18 with equipment 20 needing periodic repair. Each of the illustrated customer facilities 18 and the customer administrative office 22 has at least one customer computer 24 in communication with each other and the service provider server 12 via the communication system. 16.

The term “server” is used in the specification and claims to mean a computer configured to manage, store, send and process data 24-hours a day. The term “computer” is used in the specification and claims to mean any electronic device that can suitably communicate via a computer network including, but not limited to, desktop computers, laptop computers, notebook computers, tablet computers, smart phones, portable electronic devices or mobile devices, digital cameras, mp3 players, video game systems, messaging systems, video players, smart televisions, and the like. The terms “portable electronic device” and “mobile device” are used in the specification and claims to mean a handheld electronic device that utilizes rechargeable batteries as a power source and that that can suitably communicate with event system server via the computer network including, but not limited to, smart phones, personal digital assistants (PDAs), mp3 or other music players, video game players, messaging systems, tablet computers, notebook computers, and the like.

The illustrated service provider server 12, and the illustrated customer computers 24 are in electronic communication with one another via the communication system 16. The illustrated communication system 16 is a computer network such as the Internet but any other suitable communication system can alternatively be utilized such as, for example, an intranet, any other type network of computers, and the like.

The illustrated service provider server or computer 12 includes memory 26, at least one processor or central processing units (CPU) 28 in communication with the memory 26, one or more input/output (IO) interfaces 30 in communication with the processor 28, and at least one network interface 32 in communication with the processor 28, all of which is configured to carry out the functions and steps described herein (best shown in FIG. 1A). The illustrated memory 26 stores data files 34, an operating system (OS) 36, host applications 38 for communications with web browsers and mobile applications, security applications 40 for limiting access to authorized users, and a database management system 42 for interfacing with databases 44 having stored information. It is noted that any other suitable information and/or software can be stored in the processor 28 and/or the memory 26. The illustrated databases 44 are separate from the service provider server or computer 12 but it is noted that the databases 44 can alternatively be integrated with the service provider server or computer 12. The illustrated databases 44 are located at the service provider 14 and/or a cloud location 46 but it is noted that the databases 44 can alternatively be located at any other suitable location and/or be of any other suitable type. The illustrated databases 44 include a transaction database and a security database but any other suitable types of databases can alternatively or additionally be utilized. The at least one processor 28 can be of any suitable type. The at least one IO interface 30 can be of any suitable type such as a keyboard, a mouse, a track ball, a touch pad, a camera, a speaker, a monitor, a printer, a modem, a disk drive and the like. The network interface 32 can be of any suitable type such as, for example, a network interface card, software simulating a network card, and the like. The illustrated processor 28 and memory 26 are programmed with computer software for facilitating the method of the present invention including providing a web portal for interfacing with the customer computers 24.

The illustrated service provider server or computer 12 is located at the service provider 14 and can be accessed by customers via the communication system 16. It is noted that while the illustrated software is provided by the service provider 14 as software as a service (SaaS), the software can alternatively be provided in other suitable manners. It is also noted that while the illustrated system 10 shows a single customer, it should be appreciated that the service provider 14 typically provides such SaaS services to a plurality of different users. It is further noted that the service provider server 12 is not necessarily physically located at physical facilities of the service provider 14. In many instances the system 10 is cloud based.

Each of the illustrated customer computers 24 includes memory 48, at least one processor or central processing units (CPU) 50 in communication with the memory 48, one or more input/output (IO) interfaces 52 in communication with the processor 50, and at least one network interface 54 in communication with the processor 50, all of which is configured to carry out the functions and steps described herein (best shown in FIG. 1B). The illustrated memory 48 stores data files 56, an operating system (OS) 58, and a web browser 60. It is noted that any other suitable information and/or software can be stored in the processor 50 and/or memory 48. The at least one processor 50 can be of any suitable type. The at least one IO interface 52 can be of any suitable type such as a keyboard, a mouse, a track ball, a touch pad, a camera, a speaker, a monitor, a printer, a modem, a disk drive and the like. The network interface 54 can be of any suitable type such as, for example, a network interface card, software simulating a network card, and the like. The illustrated processor 50 and memory 48 are programmed with the web browser 60 for communicating with the web portal of the service provider server 12 as described in more detail hereinafter.

Each illustrated customer computer 24 is located at the remote sites of the customer or user such as, for example, the illustrated facilities 18 of the customer or the administrative offices 22 of the customer but it is noted that the customer computer 24 can be located at any other suitable location such as the service provider location, and the like. It is noted that the customer computer 24 can be a desktop computer or a mobile computer.

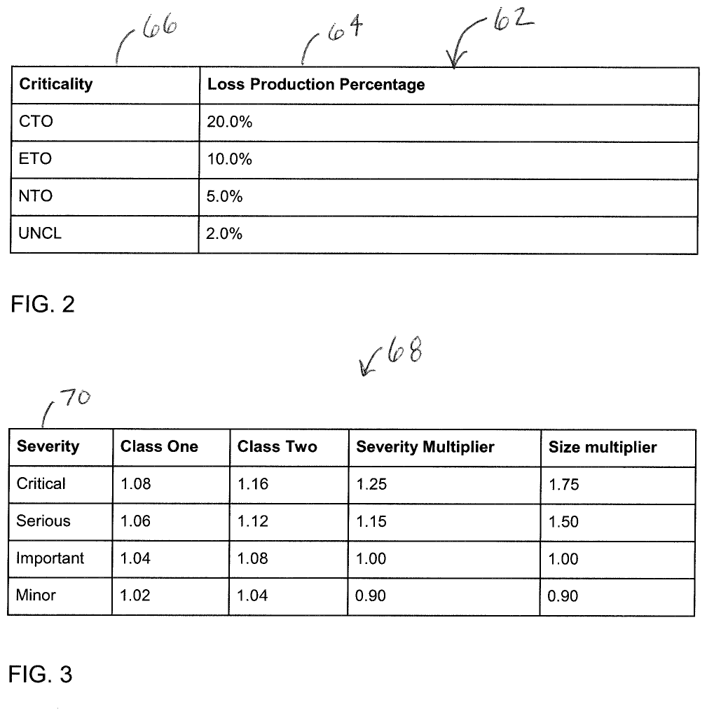

The illustrated system software or web platform resides at the service provider server 12 and is accessible to the customer via a web portal or dashboard on the customer computer 24. FIGS. 2 to 9 illustrate an exemplary method for managing maintenance and repair for facilities and/or equipment according to the present invention and exemplary display screens on the customer's computer 24 during operation of the software for carrying out the method.

The illustrated method for managing maintenance and repair of facilities and equipment according to the present invention includes the steps of collecting information about the equipment in the system. The illustrated equipment information includes horsepower and voltage for all motors in the system and gas types, such as air, and pressures of equipment in the system that could have ultrasound problems. The user or customer enters the information. The user or customer also enters cost information and production information for its facilities. The illustrated cost information includes labor rates (mechanical, electrical, lubricator), costs for gases, cost per unit of steam, and cost per KwH of electricity. The illustrated cost information includes the number of production hours per week for the facility. The processor of the service provider calculates potential cost savings for each item of equipment for the customer having a problem such that it is in need of maintenance and/or repair. The calculated cost savings predicts how much the customer will save on an annual basis by making a given repair. The potential cost savings for each item of equipment is provided by the service provider to the customer for viewing by the customer on its computer. The customer can also enter maintenance and repair information after the maintenance and/or repair of equipment has been completed. The illustrated processor of the service provider calculates overview information such as total costs and total cost savings for each facility and for all facilities of the customer. The overview information is provided to the customer by the service provider for viewing by the customer on its computer.

The formula for calculating cost savings in the illustrated method for managing maintenance and repair of facilities and equipment is: Cost Savings=Fc+Lp+E+Lm−Rc, where Fc is the Failure Cost (a variable to be calculated), Lp is the Lost Production Cost (a variable to be calculated), E is the Energy savings (a variable to be calculated), Lm is the Lost Material Cost (a variable to be calculated), and Rc is the Repair Cost (a variable to be calculated).

The illustrated formula for calculating Failure Cost (Fc) is: Failure Cost (Fc)=Flb*Lr+Fmt+Fmisc, where Flb is Failure Labor Hours (a variable to be input), Lr is the Labor Rate (a variable to be input), Fmt is the Failure Material Cost (a variable to be input), and Fmisc is the Failure Miscellaneous Cost (a variable to be input).

The illustrated formula for calculating Lost Production Cost (Lp) is: Lost Production Cost (Lp)=Ap*Flb*Cm, where Ap is the Annual Production (a variable to be input), Flb is the Failure Labor Hours (a variable to be input), and Cm is the Criticality Multiplier (a variable to be input).

The illustrated formula for calculating Energy Savings (E) is: Energy Savings (E)=Eir+Eult+Evib, where Eir is energy savings related to infra red (a variable to be calculated), Eult is energy savings related to utilities (a variable to be calculated), and Evib is energy savings related to vibration (a variable to be calculated). The illustrated formula for calculating energy savings related to infra red is: Energy Savings (Eir)=(Ctemp−Tmax)*Nc*Hw*Ec, where Ctemp is the Component temperature (a variable to be input), Tmax is the Corrected temperature (a variable to be input), Nc is the Novotny Constant (a constant), Hw is the Plant hours per week (a variable to be input), and Ec is the Energy Cost per KWH (a variable to be input). The illustrated formula for calculating energy savings related to utilities is: Energy Savings (Eult)=|Lr|/Bhp*He*Hw*52*Ec/Me, where Lr is the Leak Rate (a variable to be calculated), Bhp is 4.2 (a constant), H c is the HP Constant which is 0.746 (a constant), Hw is the Plant hours per week (a variable to be input), Ec is the Energy Cost per KWH (a variable to be input), and Me is Motor Efficiency which is 0.9 (a constant). The illustrated formula for calculating the Leak Rate is: Leak Rate (Lr)=Uc*Db\hat{ }2+PSIc*Db*Psi, where Uc is the Ultrasound Constant which is 0.00067092525 (a constant), Db is the decibels of the problem, (a variable to be input), PSIc is the PSI Constant which is 0.00033546262 (a constant), and Psi is the pressure of the gas at the problem (a variable to be input). The illustrated formula for calculating energy savings related to vibration is: Energy Savings (Evib)=Ad*V/1000*Hw*52*Ec, where Ad is the Amperage Delta (a variable to be input), V is the voltage (a variable to be input), Hw is the Plant hours per week (a variable to be input), and Ec is the Energy Cost per KWH (a variable to be input).

The illustrated formula for calculating Lost Material Cost (Lm) is: Lost Material Cost (Lm)=Gc, where Gc is the Gas Cost (a variable to be input).

The illustrated formula for calculating Repair Cost is: Repair Cost (Rc)=Rlb*Lr+Rmt+Rmisc, where Rlb is the Repair Labor Hours (a variable to be input), Lr is the Leak rate (a variable to be calculated), Rmt is the Repair Material Cost (a variable to be input), and Rmisc is the Repair Miscellaneous Cost (a variable to be input). The illustrated formula for calculating the Leak Rate is (the same as indicated above): Leak Rate (Lr)=Uc*Db\hat{ }2+PSIc*Db*Psi, where Uc is the Ultrasound Constant which is 0.00067092525 (a constant), Db is the decibels of the problem, (a variable to be input), PSIc is the PSI Constant which is 0.00033546262 (a constant), and Psi is the pressure of the gas at the problem (a variable to be input).

FIG. 2 illustrates a look up table 62 for the illustrated software which provides a loss of production percentage 64 based on a plurality of criticality indicators 66 which indicate the degree of criticality for equipment 20 in need of repair as to the operations of the customer. The illustrated criticality indicators 66 are Critical to Operation (CTO), Essential to Operation, (ESO), Non-essential to Operation (NTO), and Unclassified (UNCL). The customer determines and provides the applicable criticality indicator 66 for the equipment 20 in question and the software uses that criticality indicator 66 to establish the percentage of lost production 64 attributed the equipment failure. The criticality indicator 66 is utilized to determine the reported cost savings. It is noted that any other suitable criticality indicators 66 can alternatively be utilized such as, for example, a sequence of numbers (such as 1, 2, 3, 4), a sequence of letters (A, B, C, D,), or the like. It is also noted that while the illustrated embodiment has four criticality indicators 66, a fewer or greater of criticality indicators 66 can alternatively be utilized.

FIG. 3 illustrates a look up table 68 for the illustrated software which provides several parameters based on a plurality of severity indicators 70 which indicate the severity of the need for repair of the equipment 20. The illustrated severity indicators 70 are Critical (C), Serious, (S), Important (I), and Minor (UNCL). The severity of the problem determines the applicable severity indicator 70. The severity indicator 70 is utilized to establish certain parameters that are utilized to calculate the cost savings as discussed above. It is noted that any other suitable severity indicators 70 can alternatively be utilized such as, for example, a sequence of numbers (such as 1, 2, 3, 4), a sequence of letters (A, B, C, D,), or the like. It is also noted that while the illustrated embodiment has four severity indicators 70, a fewer or greater of criticality indicators can alternatively be utilized.

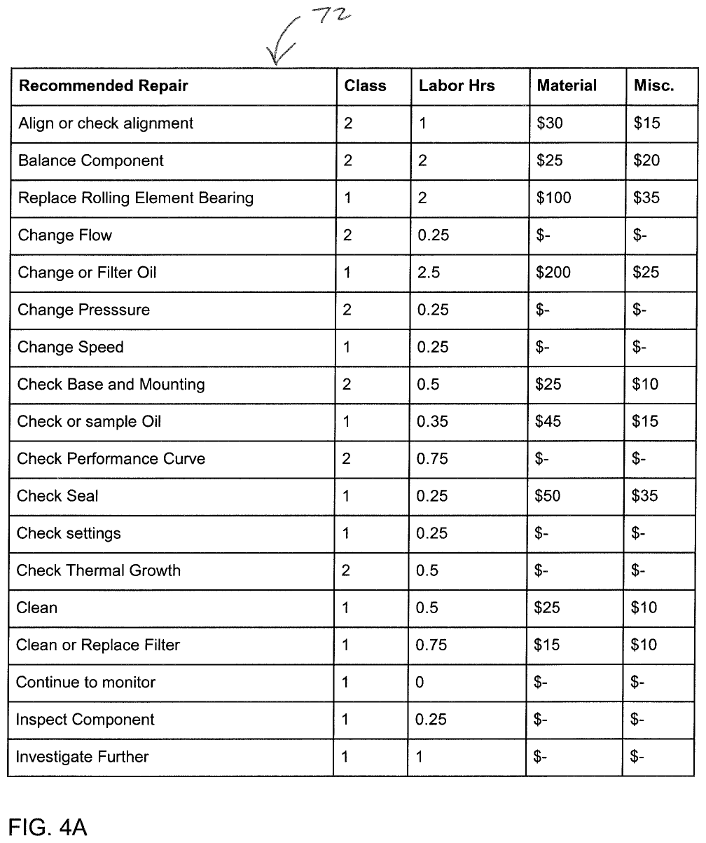

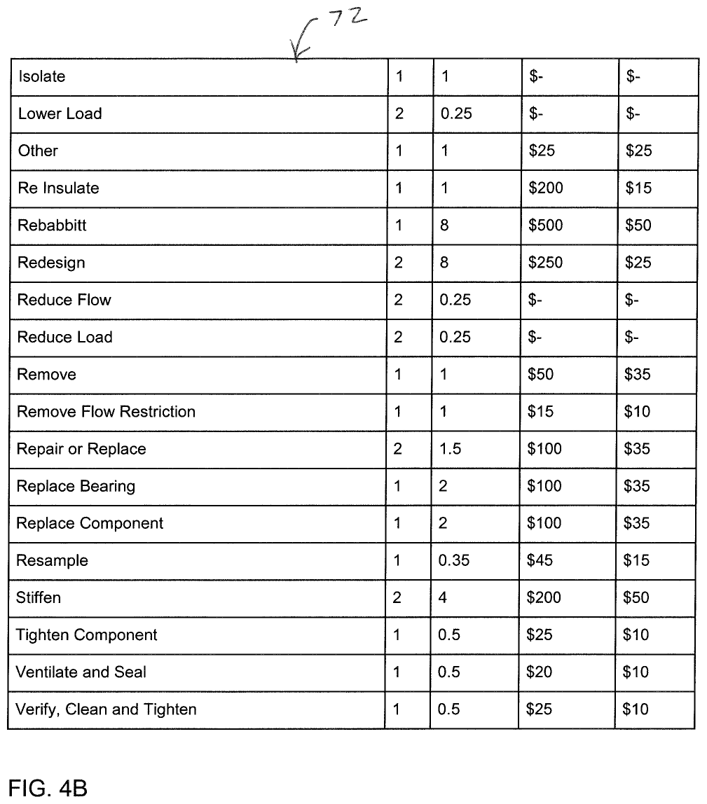

FIGS. 4A and 4B illustrates a look up table 72 for the illustrated software which provides several parameters based on a particular problem or needed repair. The illustrated parameters are Class, Labor Hours, Material Cost, and Miscellaneous Cost. The illustrated repairs are divided into two categories or classes (Class 1 and Class 2) which indicate whether the fix is easier or more complicated. Alternatively more than two classes could be utilized. The class is used to determine a multiplier and/or various parameters based on severity of the problem (for example, see FIG. 3). The Labor hours are the number of hours needed to make the given repair. The Material Cost is the cost for materials needed to make the repair. The Miscellaneous Cost is the costs associated with making the repair other than the Material Costs. These established parameters are utilized to calculate the cost savings as discussed above. It is noted that any other suitable recommended repairs can alternatively be identified and/or and other suitable quantities of recommended repairs can alternatively be utilized.

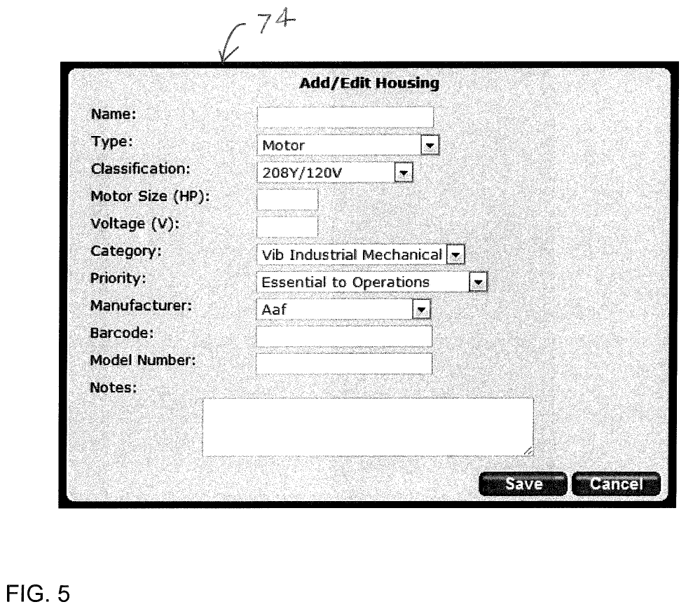

FIG. 5 illustrates a window 74 produced by the illustrated software in which the customer can input and edit information regarding a particular item of equipment. The illustrated window 74 permits the customer to input the following information: Name; Type (such as motor); Classification; Motor Size in Horsepower; Voltage in Volts, Category, Priority or Criticality Indicator, Manufacturer; barcode; Model Number, and Notes. It is noted that any other suitable equipment related inputs can alternatively be identified and/or and other suitable quantities of equipment related inputs can alternatively be utilized.

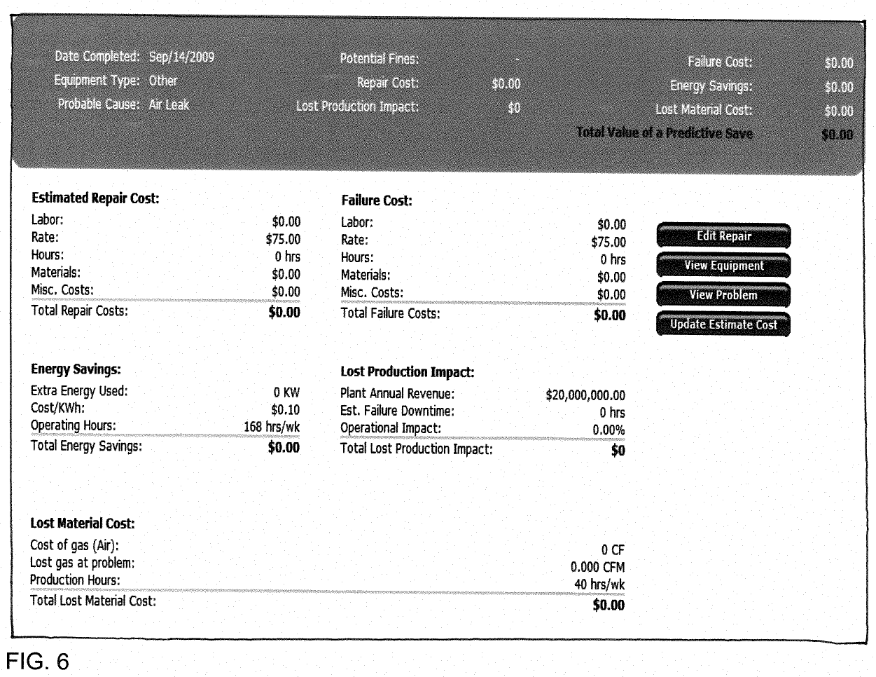

FIG. 6 is an exemplary window 76 produced by the illustrated software that reports or displays calculated costs to the customer. The illustrated window 76 displays Estimated Failure Cost, Failure Cost, energy savings, Lost Production Impact, and Lost Material Cost. It is noted that any other suitable costs and saving can alternatively be displayed and/or and other suitable quantities of costs and savings can alternatively be displayed to the customer.

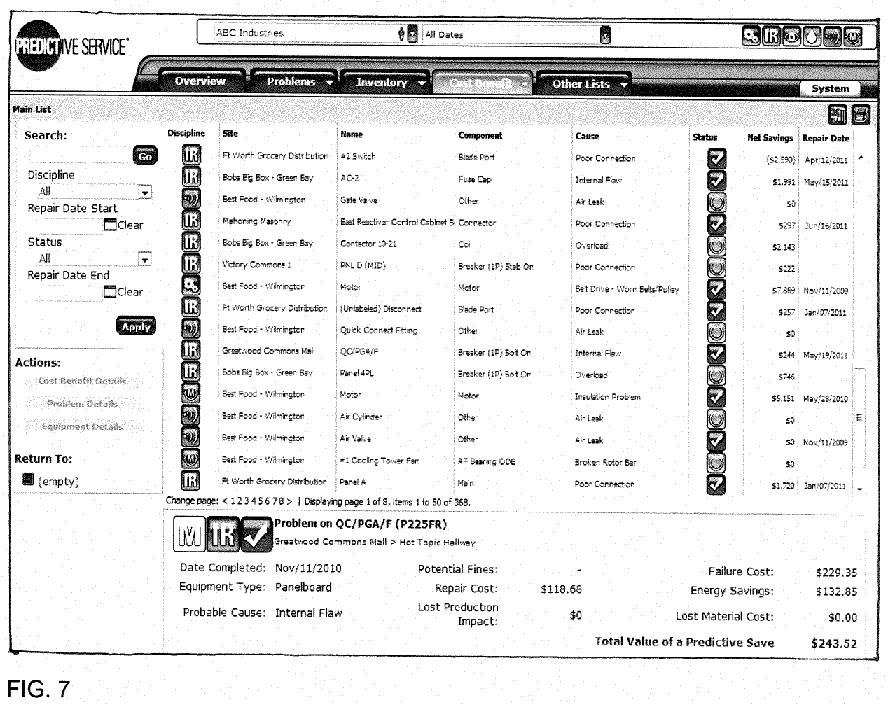

FIG. 7 is an exemplary window 78 produced by the illustrated software that reports or displays information regarding all equipment repairs for the customer. The illustrated customer has equipment repairs at multiple facilities at different locations. Summaries can be shown for specific facilities and/or equipment types so that the customer can see, for example, predicted saving for making a particular repair at all facilities, making particular repairs at a selected facility, or the like.

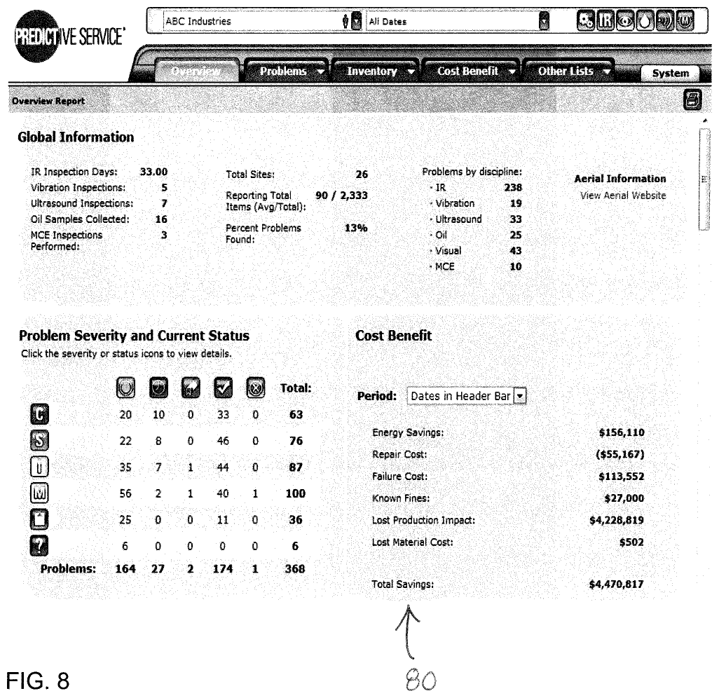

FIG. 8 is an exemplary window 80 produced by the illustrated software that reports or displays an overview report the customer. The illustrated overview report includes global information for the customer, totals based on problem severity and status, and totals for cost benefits of repairs.

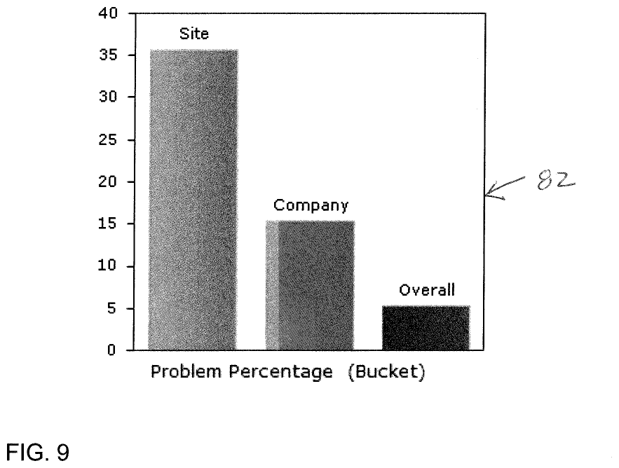

FIG. 9 is an exemplary window 82 produced by the illustrated software that reports or displays percentage of a particular piece of equipment has encountered problem. The customer selects a particular item of equipment and the software calculates and displays the percentage of that type of equipment located at a particular customer facility or site that has had a problem, the percentage of that type of equipment located at all facilities or sites of that particular customer that has had a problem, and the percentage of that type of equipment located at all facilities or sites of all customers of the service provider that has had a problem. It is noted that the customer is not able to view specific details of the equipment of other customers of the service provider other than seeing the overall percentage. The customer can use this information to identify items of equipment that have reliability problems across all companies, items of equipment that have reliability problems unique to their company, and items of equipment that have reliability problems unique o a particular facility or site.

From the forgoing disclosure and detailed description of certain preferred embodiments, it is apparent that criticality is taken into consideration in one calculation of cost savings. Constants are used so that the calculation can be automated with some customer input. The customer receives accurate, consistent reporting, even from multiple facility locations from which informed equipment repair and/or replacement decisions can be made. The illustrated software can enable a customer to achieve goals of energy savings, cost savings, or just to prevent overall failure of any kind. The illustrated software provides numerous benefits to clients of any size or any industry in any part of the world including: single source management, customized cost benefit calculations to demonstrate ROI and energy savings, online infrared and digital images of all assets with history of previous inspections including repairs and costs, asset historian for performance and PdM technologies with side by side comparisons, data management and mining for tracking, sorting, reporting and exporting, and 24/7 management and monitoring of maintenance inspections. The illustrated software also provides instantaneous benchmarking information of inspected equipment by class, indicating how an individual location's failure rates compares to all locations within a company and across our entire database of all other customers of the service provider. All benchmarking statistics are broken down by equipment class for more accurate analysis. The benchmarking information may be instantly shared across all users or designated user groups.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for determining cost benefit of making facility or equipment maintenance or repairs, comprising the steps of:
electronically receiving a criticality indicator associated with a particular facility or item of equipment from a customer;
wherein the associated criticality indicator is selected from a plurality of criticality indicators electronically presented to the customer which indicate a relative criticality of the particular facility or item of equipment for the customer;
electronically calculating a cost savings the customer can expect to obtain by making an identified maintenance or repair for the particular facility or item of equipment,
wherein the calculation is based at least in part on the criticality indicator associated with the particular facility or item of equipment; and
electronically providing the calculated cost savings to the customer.

2. The method according to claim 1, wherein the cost savings are on an annual basis.

3. The method according to claim 1, wherein the formula for calculating the cost savings is: Cost Savings−Fc+Lp+E+Lm−Rc, where Fc is the Failure Cost (a variable to be calculated), Lp is the Lost Production Cost (a variable to be calculated), E is the Energy savings (a variable to be calculated), Lm is the Lost Material Cost (a variable to be calculated), and Rc is the Repair Cost (a variable to be calculated).

4. The method according to claim 3, wherein formula for calculating Lost Production Cost is: Lost Production Cost (Lp)=Ap*Flb*Cm, where Ap is the Annual Production (a variable to be input), Flb is the Failure Labor Hours (a variable to be input), and Cm is the Criticality Multiplier (a variable to be input).

5. The method according to claim 1, further comprising the step of using the criticality indicator to establish a percentage of lost production attributed to failure of the facility or item of equipment.

6. The method according to claim 1, wherein the criticality indicators include Critical to Operation (CTO), Essential to Operation, (ESO), Non-essential to Operation (NTO), and Unclassified (UNCL).

7. The method according to claim 6, further comprising the step of using the criticality indicator to establish a percentage of lost production attributed to failure of the facility or item of equipment; wherein for the criticality indicator CTO the loss of production is about 20%, for the criticality indicator ETO the loss of production is about 10%, for the criticality indicator NTO the loss of production is about 5%, and for the criticality indicator UNCL the loss of production is about 2%.

8. A system for determining cost benefit of making facility or equipment maintenance or repairs comprising
a processor and memory configured to carry out the steps of:
electronically receiving a criticality indicator associated with a particular facility or item of equipment from a customer;
wherein the associated criticality indicator is selected from a plurality of criticality indicators electronically presented to the customer which indicate a relative criticality of the particular facility or item of equipment for the customer;
electronically calculating a cost savings the customer can expect to obtain by making an identified maintenance or repair for the particular facility or item of equipment;
wherein the calculation is based at least in part on the criticality indicator associated with the particular facility or item of equipment; and
electronically providing the calculated cost savings to the customer.

9. The system according to claim 8, wherein the cost savings are on an annual basis.

10. The system according to claim 8, wherein the formula for calculating the cost savings is: Cost Savings=Fc+Lp+E+Lm−Rc, where Fc is the Failure Cost (a variable to be calculated), Lp is the Lost Production Cost (a variable to be calculated), E is the Energy savings (a variable to be calculated), Lm is the Lost Material Cost (a variable to be calculated), and Rc is the Repair Cost (a variable to be calculated).

11. The system according to claim 10, wherein formula for calculating Lost Production Cost is: Lost Production Cost (Lp)=Ap*Flb*Cm, where Ap is the Annual Production (a variable to be input), Flb is the Failure Labor Hours (a variable to be input), and Cm is the Criticality Multiplier (a variable to be input).

12. The system according to claim 8, wherein the criticality indicator is sued to establish a percentage of lost production attributed to failure of the facility or item of equipment.

13. The system according to claim 8, wherein the criticality indicators include Critical to Operation (CTO), Essential to Operation, (ESO), Non-essential to Operation (NTO), and Unclassified (UNCL).

14. The system according to claim 13, further comprising the step of using the criticality indicator to establish a percentage of lost production attributed to failure of the facility or item of equipment; wherein for the criticality indicator CTO the loss of production is about 20%, for the criticality indicator ETO the loss of production is about 10%, for the criticality indicator NTO the loss of production is about 5%, and for the criticality indicator UNCL the loss of production is about 2%.

15. A computer readable medium containing program instructions for:
electronically receiving a criticality indicator associated with a particular facility or item of equipment from a customer;
wherein the associated criticality indicator is selected from a plurality of criticality indicators electronically presented to the customer which indicate a relative criticality of the particular facility or item of equipment for the customer;
electronically calculating a cost savings the customer can expect to obtain by making an identified maintenance or repair for the particular facility or item of equipment;
wherein the calculation is based at least in part on the criticality indicator associated with the particular facility or item of equipment; and
electronically providing the calculated cost savings to the customer.

16. The system according to claim 15, wherein the cost savings are on an annual basis.

17. The system according to claim 15, wherein the formula for calculating the cost savings is: Cost Savings=Fc+Lp+E+Lm−Rc, where Fc is the Failure Cost (a variable to be calculated), Lp is the Lost Production Cost (a variable to be calculated), E is the Energy savings (a variable to be calculated), Lm is the Lost Material Cost (a variable to be calculated), and Rc is the Repair Cost (a variable to be calculated).

18. The system according to claim 17, wherein formula for calculating Lost Production Cost is: Lost Production Cost (Lp)=Ap*Flb*Cm, where Ap is the Annual Production (a variable to be input), Flb is the Failure Labor Hours (a variable to be input), and Cm is the Criticality Multiplier (a variable to be input).

19. The system according to claim 15, wherein the criticality indicator is sued to establish a percentage of lost production attributed to failure of the facility or item of equipment.

20. The system according to claim 15, wherein the criticality indicators include Critical to Operation (CTO), Essential to Operation, (ESO), Non-essential to Operation (NTO), and Unclassified (UNCL).
